(19) United States
(12) Patent Application Publication
(10) Pub. No.: US 2010/0114444 A1
(43) Pub. Date: May 6, 2010

(54) BRAKE SYSTEM FOR A VEHICLE

(76) Inventors: Armin Verhagen, Schwieberdingen (DE); Jochen Mayer, Stuttgart-Botnang (DE); Willi Nagel, Remseck/Hochdorf (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/595,750

(22) PCT Filed: Feb. 25, 2008
(86) PCT No.: PCT/EP2008/052247

§ 371 Date: Dec. 11, 2009

(30) Foreign Application Priority Data
Apr. 10, 2007 (DE) 102007016864.2

(51) Int. Cl. G06F 19/00

(52) U.S. Cl. 701/70

(57) ABSTRACT

The invention relates to a braking system (1) comprising an actuator unit (10), said actuator unit comprising a brake pedal (2), a pedal simulator (4), and a brake servo (12), and a main brake cylinder (20) by way of which at least one wheel brake (42, 44, 46, 48) may be actuated, said wheel brake having a braking pressure that may be predetermined, wherein the brake pedal (2) or the brake servo (12) acts on the main brake cylinder (20) to increase or decrease a braking force. According to the invention, during a first operating mode, preferably a brake-by-wire operating mode, the braking force amplifier (12), controlled by an analysis and control unit (11), generates an outside force that acts on a piston (21) of the main brake cylinder (20), wherein the actuator unit (10) comprises a first transmission device (5) that, controlled by the analysis and control unit (11), mechanically decouples the brake pedal (2) from the piston (21) of the main brake cylinder (20) as a function of predetermined criteria during the first operating mode, or couples the brake pedal (2) to the piston (21) of the main brake cylinder (20) such that the pedal force generated at the brake pedal (2) additionally acts at least partially on the piston (21) of the main brake cylinder (20).

### PRIOR ART

The invention is based on a brake system for a vehicle as generically defined by the preamble to independent claim 1.

The definition of a brake-by-wire brake system describes a so-called power-brake system, in which, without direct transmission of the muscle power of the driver to the element that generates braking moment, the requisite braking moment is generated with a brake booster. Such brake-by-wire brake systems as a rule have a pedal simulator, which is active during the brake-by-wire mode of operation and simulates a pedal characteristic (force/travel curve), corresponding to the braking event, for the driver. In a failure of the brake-by-wire mode of operation, the pedal simulator is as a rule bypassed and thus becomes inoperative. Brake systems in which the foot power is employed in addition to a boosting force generated by a brake booster are known as auxiliary force brake systems, which are widely used in the passenger car field.

In the Published International Patent Application WO 2005/014351 A1, a so-called brake-by-wire brake system is described. The described brake system is actuated by a brake actuation unit, which includes a brake booster, embodied as an underpressure brake booster, a master cylinder connected downstream of the brake booster, means for detecting a driver's demand for deceleration, and a pedal travel simulator. The brake booster can be actuated either by means of a brake pedal or by means of an electronic control unit in accordance with the demands of the driver, and means are present that uncouple a force-transmitting connection between the brake pedal and the brake booster during the brake-by-wire mode of operation. During the brake-by-wire mode of operation, independently of an actuation of the brake booster, the pedal travel simulator simulates a restoring force acting on the brake pedal, and during the brake-by-wire mode of operation, upon uncoupling of the force-transmitting connection between the brake pedal and the brake booster, the pedal travel simulator can be turned on and shut off outside the brake-by-wire mode of operation. Turning the pedal travel simulator on and off is done by electromechanical, electrohydraulic or pneumatic switching means.

In U.S. Pat. No. 6,634,724 B2, a conventional brake system with an electromechanical brake booster is described. In the described electromechanical brake booster, driven by an electric motor, during operation the rotary motion of the electric motor is converted into a translational motion to boost the brake force. The conversion of the rotation to a translation is effected by means of a rack-and-pinion combination. The brake booster described is part of a power-assisted brake system, in which the actual brake force is generated by means of an addition of a pedal force, which is exerted by the driver, and an auxiliary force that is exerted by the brake booster.

### DISCLOSURE OF THE INVENTION

The brake system of the invention having the characteristics of independent claim 1 has the advantage over the prior art that during a first mode of operation, preferably a brake-by-wire brake system, the brake booster, controlled by an evaluation and control unit, generates an external force which acts on a piston of the master cylinder, and a first transmission device, which is part of the actuator unit and is controlled by the evaluation and control unit, mechanically uncouples the brake pedal from the piston of the master cylinder as a function of predetermined criteria during the first mode of operation, or couples the brake pedal to the piston of the master cylinder in such a way that the pedal force generated at the brake pedal additionally acts at least partially on the piston of the master cylinder. The brake system of the invention advantageously makes intermediate states between a purely power-brake system and a power-assisted brake system possible. Because it is possible, in the event of a total failure of the brake-by-wire mode of operation or in the event of fading, that is, a loss of friction or of braking torque between the brake lining and brake disk because of high temperature, for an additional amount of brake force to be exerted by the driver to reinforce the brake system, “mixed braking” is possible. Thus if need be, the muscle power of the driver can be used in a purposeful way. Furthermore, by means of a pedal simulator, feedback corresponding to the braking to the driver can be achieved. Compared to a purely brake-by-wire brake system, there is the advantage that the foot power of the driver is employed not only in the event of a complete failure of the brake-by-wire mode of operation, but also in a partial failure of the brake-by-wire mode of operation, which can be caused by a voltage drop, voltage fluctuations, overheating, and so forth, as well as in the event of fading. Moreover, idle travel of the brake pedal that may occur during the bypassing of the pedal simulator can advantageously be avoided.

By the provisions and refinements recited in the dependent claims, advantageous improvements to the brake system defined by the independent claim are possible.

It is especially advantageous that the brake pedal is coupled to the pedal simulator and to the first transmission device, which is embodied for instance as a locking device or as a force shunt. The pedal simulator and/or a sensor unit, during the first mode of operation, detects a demand for deceleration at the brake pedal and ascertains a corresponding pedal force and forwards the outcome of detection and/or ascertainment to the evaluation and control unit, which triggers the brake booster for generating the corresponding external force. Moreover, the pedal simulator generates a corresponding haptic feedback and outputs it to the brake pedal. The locking device as needed advantageously establishes a form-locking connection between the brake pedal and the master cylinder. Thus the possibility exists of coupling the pedal force generated at the brake pedal to the piston of the master cylinder not only after a long idle travel but also without any significant travel loss. The idle travel serves during normal operation to uncouple the brake pedal and the master cylinder mechanically. Alternatively, the force shunt advantageously enables a continuous distribution of the pedal force, generated by the driver at the brake pedal, to the pedal simulator and to the piston of the master cylinder. With the force shunt, the foot power of the driver can be employed suitably as a function of the current system state, that is, as a function of normal operation, of a complete failure of the brake-by-wire mode of operation, of a partial failure of the brake-by-wire mode of operation, in fading, and so forth. Because of the force shunt, there are likewise no idle or bypassing travels when the brake pedal is actuated while the pedal simulator is bypassed.

In a feature of the brake system of the invention, the brake booster is embodied as an electromechanical brake booster, which includes an electric motor and a second transmission device that transmits the torque, generated by the electric motor), at a predeterminable stepup as a translational external force to the piston of the master cylinder. The second transmission device is embodied for instance as a gear mechanism), which includes a rack that is connected to a coupling plunger and also includes a pinion, and the coupling plunger is coupled to the piston of the master cylinder. The gear ratio can be predetermined for instance via the embodiment of the rack and via the embodiment of the pinion. Alternatively, the second transmission device may be embodied as a threaded drive mechanism, which includes a driven hollow shaft in which the coupling plunger is longitudinally movably guided.

In a further feature of the brake system of the invention, the locking device couples the brake pedal as needed to the piston of the master cylinder in such a way that the pedal force generated at the brake pedal acts fully on the piston of the master cylinder. The locking device includes for instance two sleeves that are displaceable inside one another, of which the outer sleeve is embodied as part of the coupling plunger, and the inner sleeve is embodied as part of a coupling rod that is connected to the brake pedal. Moreover, in the inner sleeve there is at least one ball, and preferably two, which for locking the inner sleeve to the outer sleeve can be pressed outward by a bolt, guided longitudinally movably in the inner sleeve, from an outset position through at least one corresponding opening in the inner sleeve into corresponding receiving depressions in the outer sleeve. The bolt is kept by a retention device, which is embodied for instance as an electromagnet, in an outset position in which the coupling rod is mechanically uncoupled from the coupling plunger. Thus the inner sleeve, in the outset position of the bolt and of the at least one ball, can be moved in a mechanically uncoupled way inside the outer sleeve; that is, in the outset position of the bolt and of the at least one ball no force transmission takes place from the coupling rod to the coupling plunger. For mechanically coupling the coupling rod to the coupling plunger, the evaluation and control unit deactivates the retention device, as a result of which the bolt, which is subjected to force by a spring, moves inside the inner sleeve in such a way that the at least one ball is pressed outward from its outset position by the bolt into the corresponding receiving depressions in the outer sleeve, so that the inner sleeve is locked to the outer sleeve. Thus between the inner sleeve and the outer sleeve, a form-locking connection exists, and force transmission can take place from the coupling rod to the coupling plunger and thus to the piston of the master cylinder. In this state, the piston of the master cylinder can be subjected to a force both via the brake pedal and via the brake booster, so that the brake force at the piston of the master cylinder is composed of the pedal force and the brake force.

In a further feature of the brake system of the invention, the force shunt couples the brake pedal as needed to the piston of the master cylinder in such a way that the proportion of the pedal force, generated at the brake pedal, that acts on the piston of the master cylinder is continuously variably adjustable. The brake pedal is coupled, for instance at a first coupling point, to a coupling rod which transmits the pedal force generated at the brake pedal to the pedal simulator and to the piston of the master cylinder via the force shunt. The force shunt is embodied for instance as a lever with a guide, in which one end, acting as a pivot point, of the coupling rod is guided. The lever ratio between a second coupling point, at which the pedal simulator is coupled to the force shunt via a first transmission rod, and a third coupling point, at which the piston of the master cylinder is coupled to the force shunt via a second transmission rod, can be adjusted by displacement of the pivot point. The proportion of the pedal force acting on the piston of the master cylinder is adjustable via the lever ratio. The force shunt makes it possible for the pedal force, generated by the driver at the brake pedal, to be distributed in a continuously variable way between the pedal simulator and the master cylinder, so that the foot power exerted by the driver can act fully, in the case of a complete failure of the brake-by-wire mode of operation, or partially on the master cylinder. The displacement of the pivot point can be accomplished by means of an electric actuator.

In a further feature of the brake system, during a second mode of operation, preferably an emergency mode of operation, the brake pedal is coupled mechanically to the piston of the master cylinder, in order to transmit the pedal force, generated at the brake pedal, fully to the piston of the master cylinder, and during the second mode of operation, the pedal simulator is deactivated and/or bypassed.

Advantageous embodiments of the invention that are described below are shown in the drawings.

### BRIEF DESCRIPTION OF THE DRAWINGS

FIG. 1 shows a schematic block circuit diagram of a first embodiment of a brake system according to the invention.

FIG. 2 is a schematic detailed view of an exemplary embodiment of a first transmission device, embodied as a locking device, from FIG. 1.

FIG. 3 shows a schematic block circuit diagram of a second embodiment of a brake system according to the invention.

FIG. 4 is a schematic detailed view of an exemplary embodiment of a first transmission device, embodied as a force shunt, from FIG. 3.

### EMBODIMENTS OF THE INVENTION

In the drawings, identical reference numerals identify elements and components that perform the same or analogous functions.

As can be seen from FIG. 1, a first embodiment of a brake system 1 according to the invention includes an actuator unit 10, which has a brake pedal 2; a pedal simulator 4; a first transmission device, embodied as a locking device 5; and a brake booster, which is embodied here as an electromechanical brake booster 12; a master cylinder 20; a fluid control block 30; and a plurality of wheel brakes 42, 44, 46, 48, which are triggered at a predeterminable brake pressure via the master cylinder 20 and the fluid control block 30. The master cylinder 20 is embodied for example as a tandem master cylinder and communicates via suitable fluid connections with a fluid tank 22, which is used as a compensation tank for the brake fluid, and the downstream fluid block 30. The brake pedal 2 is connected to the pedal simulator 4 and to a coupling rod 3 that is embodied as part of the locking device 5. The electromechanical brake booster 12 includes an electric motor 13 and a second transmission device 14, which transmits the torque generated by the electric motor 13, or the external force generated, via a coupling plunger 23 to a piston 21 of the master cylinder 20. Thus the second transmission device 14, for triggering the master cylinder 20, can convert a rotary motion into a translational motion and can transmit the torque, generated by the electric motor 13, at a predeterminable gear ratio to the piston 21 of the master cylinder 20. To achieve a suitable gear ratio, the second transmission device 14 may be embodied with multiple stages. For implementation of the electromechanical brake booster 12, a suitable electric drive mechanism may be coupled to an arbitrary second transmission device 14—for instance, a worm wheel drive, belt drive, chain drive, and so forth may be used—in order to subject the piston 21 of the master cylinder 20 suitably to an external force for adjusting a brake pressure.

In the first exemplary embodiment shown in FIG. 1, the second transmission device is embodied as a gear mechanism 14, which includes a rack 14.1, connected to the coupling plunger 23, and a pinion 14.2. In the exemplary embodiment shown, the rack 14.1 is integrated directly with the coupling plunger 23. The gear ratio may be predetermined via the embodiment of the rack 14.1 and via the embodiment of the pinion 14.2. As can also be seen from FIG. 1, the rack 14.1 is coupled to the piston 21 of the master cylinder 20 via the coupling plunger 23, and during a first mode of operation, which here corresponds to a brake-by-wire mode of operation, it is driven by the electric motor 13 via the pinion 14.2. During the first mode of operation, the pedal simulator 4, or a sensor unit, not shown, detects a demand for deceleration at the brake pedal 2, ascertains a corresponding pedal force, and forwards the outcome of detection and/or ascertainment to the evaluation and control unit 11 or 11′, which triggers the electromechanical brake booster 12 for generating the appropriate external force. In addition, the pedal simulator 4 generates a corresponding pedal reaction or haptic feedback and outputs that to the brake pedal 2.

In error-free operation, the brake system 1 is operated in a brake-by-wire mode of operation; that is, the pedal force generated by the muscle power of the driver is transmitted not to the element that generates braking moment, in this case to the master cylinder 20; instead, the evaluation and control unit 11 generates the required brake force with only the electromechanical brake booster 12, and the evaluation and control unit 11 in this error-free case, by means of suitable triggering of the first transmission device, mechanically uncouples the brake pedal 2 completely from the piston 21 of the master cylinder 20. In addition, during a brake slip control event and/or a brake pressure regulating event, the evaluation and control unit 11 can ascertain a current brake pressure in the brake system 1 via at least one sensor unit 60 and can adjust the brake force accordingly, via the electromechanical brake booster 12, in order to increase or reduce the current brake pressure. Various functions involving passenger comfort and safety can therefore be implemented, such as a brake assistance function, an ACC function, a soft stop function, a hill hold function, an emergency braking function independently of the driver, and so forth.

In the event of a partial failure of the brake-by-wire mode of operation, which can be caused for instance by a voltage drop, voltage fluctuations, overheating, and so forth, or in the case of fading, that is, in a loss of friction or a loss of braking moment between the brake lining and a brake disk because of high temperature, the evaluation and control unit 11 triggers the first transmission device in such a way that a form-locking connection is brought about between the brake pedal 2 and the piston 21 of the master cylinder 20. As a result, in addition to the external force exerted by the brake booster 12, a pedal force exerted by the driver can be employed for reinforcing the brake system. Thus if needed, the muscle power of the driver can be purposefully employed, and by means of the pedal simulator 4, via the brake pedal 2, the driver is given feedback corresponding to the braking.

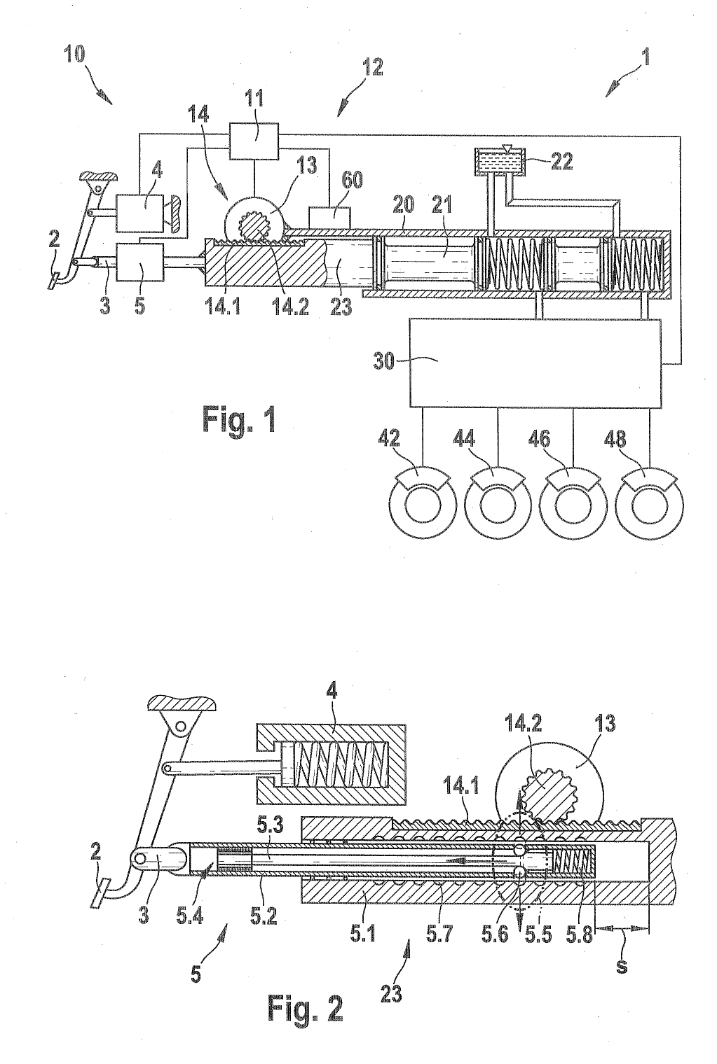

As can be seen from FIG. 2, the first transmission device, embodied as a locking device 5, includes two sleeves 5.1, 5.2 that are displaceable axially inside one another, of which the outer sleeve 5.1 is embodied as part of the coupling plunger 23, and the inner sleeve 5.2 is embodied as part of the coupling rod 3 that is connected to the brake pedal 2. In the exemplary embodiment shown, there are the two balls 5.6 in the inner sleeve 5.2, and in order to lock the inner sleeve 5.2 to the outer sleeve 5.1, these balls can be pressed outward inside the inner sleeve 5.2 out of the outset position into suitable receiving depressions 5.7 in the outer sleeve 5.1 via corresponding openings in the inner sleeve 5.2 by a bolt 5.3 guided longitudinally movably in the inner sleeve 5.2. Alternatively, more or fewer than two balls 5.6 may be employed for locking the inner sleeve 5.2 to the outer sleeve 5.1. During error-free operation, the bolt 5.3 is kept in the outset position by a retention device 5.4, which is embodied for instance as an electromagnet, and in this position the two balls 5.6 are disposed inside the inner sleeve 5.2, and the coupling rod 3 is mechanically uncoupled from the coupling plunger 23. Upon an actuation of the brake pedal 2, the coupling rod 3, embodied as the inner sleeve 5.2, is moved inside the coupling plunger 23 embodied as the outer sleeve 5.1, and a spacing s between a face end of the coupling rod 3 and an inner stop in the coupling plunger 23 serves, in the error-free case, to mechanically uncouple the brake pedal 2 from the piston 21 of the master cylinder 20.

If the evaluation and control unit 11 detects a partial failure of the brake-by-wire mode of operation, then the evaluation and control unit 11 deactivates the retention device 5.4, and as a result, the bolt 5.3, which is subjected to a force by a spring 5.8, moves inside the inner sleeve 5.2. As a result of the longitudinal motion of the bolt 5.3, which in terms of the view in FIG. 2 is equivalent to a movement of the bolt 5.3 in the direction of the arrow toward the left, the two balls 5.6 are pressed outward via suitable flanks on the bolt 5.3, out of their outset position, through the corresponding openings in the inner sleeve 5.2 into the corresponding receiving depressions 5.7 of the outer sleeve 5.1 and establish a form-locking connection 5.5 between the two sleeves 5.2 and 5.1. This position of the two balls 5.6 is represented by a line of dashes and two dots in FIG. 2. As a result, the coupling rod 3 is coupled mechanically to the coupling plunger 23, and a pedal force generated by the driver at the brake pedal 2 is transmitted via the coupling plunger 23 to the piston 21 of the master cylinder 20. The possibility thus exists of not mechanically coupling the coupling rod 3 to the coupling plunger 23 only after a long idle travel, or in other words after the bypassing of the spacing s, but instead of establishing it without significant travel loss.

In a complete failure of the brake-by-wire mode of operation, a mechanical connection between the brake pedal 2 and the piston 21 of the master cylinder 20 is established by providing that the pedal simulator 4 is shut off or bypassed, and the retention device 5.4 inside the inner sleeve 5.2 is deactivated. By the shutoff or bypassing of the pedal simulator 4 and by the deactivation of the retention device 5.4, a second mode of operation, that is, the emergency mode of operation, is activated, during which the coupling rod 3, via the form-locking connection 5.5, is mechanically coupled to the coupling plunger 23, so that the pedal force, generated by the muscle power of the driver at the brake pedal 2, is transmitted to the piston 21 of the master cylinder 20. As a result, it is possible for the driver to actuate the brake system without reinforcement from the electromechanical brake booster 12.

From the above discussion it can be seen that the brake pedal 2, during an error-free brake-by-wire mode of operation, is coupled only to the pedal simulator 4. In a partial failure of the brake-by-wire mode of operation, the brake pedal is coupled to both the pedal simulator 4 and the piston 21 of the master cylinder 20. In a complete failure of the brake-by-wire mode of operation, the brake pedal 2 is coupled only to the piston 21 of the master cylinder 20.

The second embodiment, shown in FIG. 3, of a brake system 1′ differs from the first embodiment of the brake system 1 of the invention shown in FIG. 1 in terms of the first transmission device embodied as a force shunt 6. Elements and components that perform the same or analogous functions are identified by the same reference numerals in FIGS. 1 and 3, so that a repeat of a detailed description of these elements and components can be dispensed with.

As can be seen from FIG. 3, the second embodiment of a brake system 1′ according to the invention, analogously to the first embodiment of FIG. 1, includes an actuator unit 10′, which has a brake pedal 2′, a pedal simulator 4, a first transmission device, and an electromechanical brake booster 12, and the first transmission device, unlike the first embodiment, is embodied as a force shunt 6 and not as a locking device 5; the actuator unit also has a master cylinder 20 with a fluid tank 22; a fluid control block 30; and a plurality of wheel brakes 42, 44, 46, 48, which are triggered at a predeterminable brake pressure via the master cylinder 20 and the fluid control block 30. The brake pedal 2 is connected to the force shunt 6 via a coupling rod 3′. Analogously to the first embodiment, the electromechanical brake booster 12 includes an electric motor 13 and a second transmission device 14, which for triggering the master cylinder 20 converts a rotary motion of the electric motor 13 into a translational motion and transmits the torque, generated by the electric motor 13, at a predeterminable gear ratio via a coupling plunger 23′ to the piston 21 of the master cylinder 20, in order to subject the piston 21 of the master cylinder 20 to an external force in order to adjust a brake pressure accordingly.

Analogously to the first exemplary embodiment in FIG. 1, the second transmission device is embodied as a gear mechanism 14, which includes a rack 14.1, connected to the coupling plunger 23′, and a pinion 14.2. In the exemplary embodiment shown, the rack 14.1 is integrated directly with the coupling plunger 23, so that during the brake-by-wire mode of operation, the piston 21 of the master cylinder 20 is driven by the electric motor 13 via the pinion 14.2 and the rack 14.1.

The force shunt 6 is embodied such that the pedal force generated by the driver at the brake pedal 2′, which force is transmitted to the force shunt 6 via the coupling rod 3′, can be distributed in a continuously variable way, as a function of the predetermined criteria, between the pedal simulator 4 and the piston 21 of the master cylinder 20. As a result, analogously to the first embodiment in FIG. 1, it is possible to cause the pedal force exerted by the driver to act fully on the piston 21 of the master cylinder 20 in the event of a complete failure of the brake-by-wire mode of operation. Furthermore, the force shunt 6, in the error-free case, can conduct the pedal force generated by the driver completely to the pedal simulator 4. However, in a distinction from the first embodiment of FIG. 1, the force shunt, in a partial failure of the brake-by-wire mode of operation or in the case of fading, makes it possible for the pedal force generated by the driver at the brake pedal 2′ to be carried only partly to the piston 21 of the master cylinder 20. During the first mode of operation, the pedal simulator 4 or a sensor unit, not shown, detects a demand for deceleration at the brake pedal 2′, ascertains a corresponding pedal force, and forwards the outcome of detection and/or ascertainment to the evaluation and control unit 11′, which triggers the electromechanical brake booster 12′ for generating the appropriate external force. In addition, the pedal simulator 4 generates a corresponding pedal reaction or haptic feedback and outputs it to the brake pedal 2 via the force shunt 6.

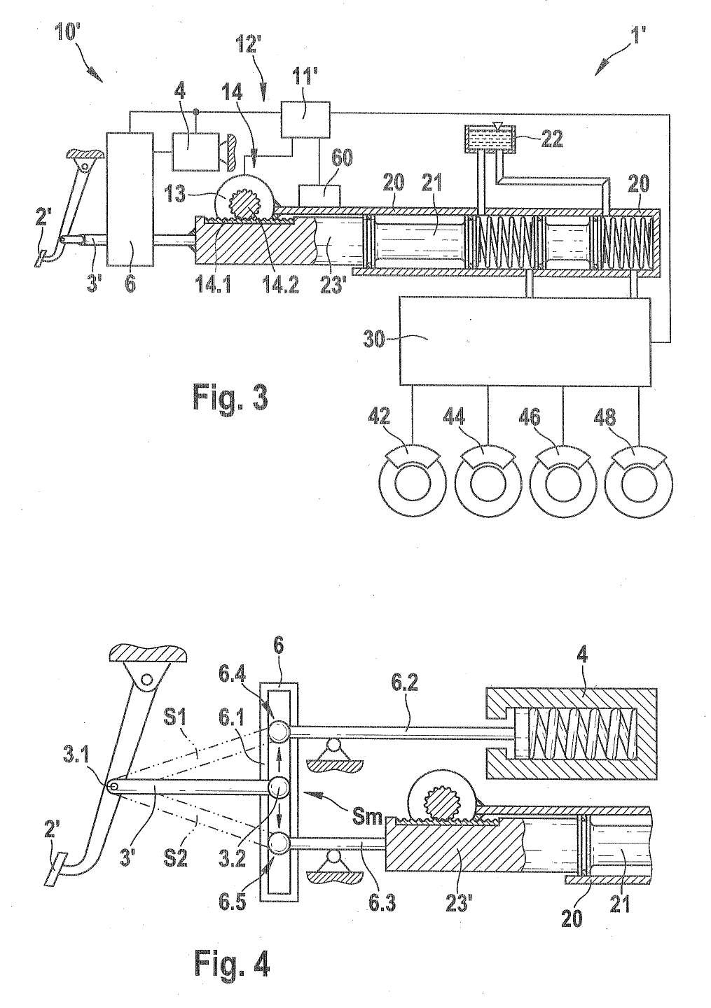

As can be seen from FIG. 4, the first transmission device embodied as a force shunt 6 is embodied as a lever, with a guide 6.1 in which one end, acting as a pivot point 3.2, of the coupling rod 3′ is guided, the coupling rod being coupled to the brake pedal 2′ at a first coupling point 3.1. By displacement of the pivot point 3.2 inside the guide 6.1 of the force shunt 6, the lever ratio can be adjusted between a second coupling point 6.4, at which the pedal simulator 4 is coupled to the force shunt 6 via a first transmission rod 6.2, and a third coupling point 6.5, at which the piston 21 of the master cylinder 20 is coupled to the force shunt 6, via the coupling plunger 23′ and a second transmission rod 6.3. Via the lever ratio, the proportion of the pedal force acting on the piston 21 of the master cylinder 20 or the proportion of the pedal force acting on the pedal simulator 4 can adjusted to between 0 and 100%. In the middle position Sm shown of the pivot point 3.2, 50% of the pedal force is transmitted to the pedal simulator 4, and 50% of the pedal force is transmitted to the piston 21 of the master cylinder 20. In the position S1 of the coupling rod 3′ and of the pivot point 3.2 as shown in lines of dashes and two dots, 100% of the pedal force is transmitted to the pedal simulator 4; this corresponds to the position in the error-free case. In the position S2, shown in lines of dashes and two dots, of the coupling rod 3′ and of the pivot point 3.2, 100% of the pedal force is transmitted to the piston 21 of the master cylinder 20; this corresponds to the position in the emergency mode of operation, or in other words upon a complete failure of the brake-by-wire mode of operation. Via a displacement device, not shown, the evaluation and control unit 11′ can vary the introduction of the pedal force continuously as needed, as a function of the system state, between the pedal simulator 4 and the piston 21 of the master cylinder 20. The displacement of the pivot point 3.2 can for instance be executed by an electric actuator. Thus the first transmission device embodied as a force shunt 6 also makes it possible for the brake pedal 2′, during the emergency mode of operation, to be coupled to the piston 21 of the brake cylinder 20 without idle travel.

In an alternative embodiment, not shown, the second transmission device is embodied as a threaded drive mechanism, which includes a hollow shaft in which the coupling plunger 23, 23′ is guided longitudinally movably, in order to transmit the external force, generated by an electric motor, and/or the pedal force, generated by the driver at the brake pedal, to the piston 21 of the master cylinder 20.

In a further, alternative embodiment, not shown, of the brake system of the invention, the brake booster is embodied as an underpressure brake booster, and the coupling plunger 23, 23′ in such an embodiment acts on the master cylinder via the underpressure brake booster.

With the brake system of the invention, in the event of a partial failure of the brake-by-wire mode of operation or in the event of fading, an additional amount of brake force for reinforcing the brake system can be brought to bear by the driver. Thus if needed, the muscle power of the driver can be used, and by means of the pedal simulator, feedback corresponding to the braking can be realized as well. This “mixed braking” can be attained for instance with the embodiments of the invention described, which suitably coordinate the pedal force exerted by the driver and the contrary force generated by the pedal simulator as well as the force exerted if need be directly by the driver on the master cylinder.

1-10. (canceled)

11. A brake system comprising:
an actuator unit, which unit includes a brake pedal, a pedal simulator, a brake booster, and a first transmission device;
a master cylinder by way of which at least one wheel brake is triggerable at a predeterminable brake pressure, and the brake pedal or the brake booster acts to build up or reduce a brake pressure on the master cylinder; and
an evaluation and control unit, the first transmission device being controlled by the evaluation and control unit,
wherein during a first mode of operation, preferably in a brake-by-wire brake system, the brake booster, controlled by the evaluation and control unit, generates an external force which acts on a piston of the master cylinder, and the first transmission device of the actuator unit, which controlled by the evaluation and control unit mechanically uncouples the brake pedal from the piston of the master cylinder as a function of predetermined criteria during the first mode of operation, or couples the brake pedal to the piston of the master cylinder in such a way that the pedal force generated at the brake pedal additionally acts at least partially on the piston of the master cylinder.

12. The brake system as defined by claim 11, wherein the brake pedal is coupled to the pedal simulator and to the first transmission device, which is embodied as a locking device or as a force shunt, and the pedal simulator and/or a sensor unit, during the first mode of operation, detects a demand for deceleration at the brake pedal and ascertains a corresponding pedal force and forwards an outcome of detection and/or ascertainment to the evaluation and control unit, which triggers the brake booster for generating a corresponding external force, and the pedal simulator generates a corresponding haptic feedback and outputs the feedback to the brake pedal.

13. The brake system as defined by claim 11, wherein the brake booster is an electromechanical brake booster that includes an electric motor and a second transmission device, which transmission device transmits the torque, generated by the electric motor, at a predeterminable stepup as a translational external force to the piston of the master cylinder.

14. The brake system as defined by claim 12, wherein the brake booster is an electromechanical brake booster that includes an electric motor and a second transmission device, which transmission device transmits the torque, generated by the electric motor, at a predeterminable stepup as a translational external force to the piston of the master cylinder.

15. The brake system as defined by claim 13, wherein the second transmission device is embodied as a gear mechanism, which includes a rack that is connected to a coupling plunger and also includes a pinion, or is embodied as a threaded drive mechanism, which includes a driven hollow shaft in which the coupling plunger is longitudinally movably guided, and the coupling plunger is coupled to the piston of the master cylinder.

16. The brake system as defined by claim 14, wherein the second transmission device is embodied as a gear mechanism, which includes a rack that is connected to a coupling plunger and also includes a pinion, or is embodied as a threaded drive mechanism, which includes a driven hollow shaft in which the coupling plunger is longitudinally movably guided, and the coupling plunger is coupled to the piston of the master cylinder.

17. The brake system as defined by claim 12, wherein the locking device couples the brake pedal as needed to the piston of the master cylinder in such a way that the pedal force generated at the brake pedal acts fully on the piston of the master cylinder.

18. The brake system as defined by claim 14, wherein the locking device couples the brake pedal as needed to the piston of the master cylinder in such a way that the pedal force generated at the brake pedal acts fully on the piston of the master cylinder.

19. The brake system as defined by claim 16, wherein the locking device couples the brake pedal as needed to the piston of the master cylinder in such a way that the pedal force generated at the brake pedal acts fully on the piston of the master cylinder.

20. The brake system as defined by claim 17, wherein the locking device includes two sleeves that are displaceable inside one another, of which an outer sleeve is embodied as part of the coupling plunger, and an inner sleeve is embodied as part of a coupling rod that is connected to the brake pedal, and disposed in the inner sleeve there is at least one ball which for locking the inner sleeve to the outer sleeve is pressed outward by a bolt and guided longitudinally movably in the inner sleeve from an outset position through at least one corresponding opening in the inner sleeve into corresponding receiving depressions in the outer sleeve, and the bolt is kept by a retention device in an outset position in which the coupling rod is mechanically uncoupled from the coupling plunger.

21. The brake system as defined by claim 18, wherein the locking device includes two sleeves that are displaceable inside one another, of which an outer sleeve is embodied as part of the coupling plunger, and an inner sleeve is embodied as part of a coupling rod that is connected to the brake pedal, and disposed in the inner sleeve there is at least one ball which for locking the inner sleeve to the outer sleeve is pressed outward by a bolt and guided longitudinally movably in the inner sleeve from an outset position through at least one corresponding opening in the inner sleeve into corresponding receiving depressions in the outer sleeve, and the bolt is kept by a retention device in an outset position in which the coupling rod is mechanically uncoupled from the coupling plunger.

22. The brake system as defined by claim 19, wherein the locking device includes two sleeves that are displaceable inside one another, of which an outer sleeve is embodied as part of the coupling plunger, and an inner sleeve is embodied as part of a coupling rod that is connected to the brake pedal, and disposed in the inner sleeve there is at least one ball which for locking the inner sleeve to the outer sleeve is pressed outward by a bolt and guided longitudinally movably in the inner sleeve from an outset position through at least one corresponding opening in the inner sleeve into corresponding receiving depressions in the outer sleeve, and the bolt is kept by a retention device in an outset position in which the coupling rod is mechanically uncoupled from the coupling plunger.

23. The brake system as defined by claim 20, wherein for mechanically coupling the coupling rod to the coupling plunger, the evaluation and control unit deactivates the retention device, as a result of which the bolt, which is subjected to force by a spring, moves inside the inner sleeve in such a way that the at least one ball is pressed outward from its outset position by the bolt into at least one of the corresponding receiving depressions in the outer sleeve, so that the inner sleeve forms a form-locking connection with the outer sleeve.

24. The brake system as defined by claim 21, wherein for mechanically coupling the coupling rod to the coupling plunger, the evaluation and control unit deactivates the retention device, as a result of which the bolt, which is subjected to force by a spring, moves inside the inner sleeve in such a way that the at least one ball is pressed outward from its outset position by the bolt into at least one of the corresponding receiving depressions in the outer sleeve, so that the inner sleeve forms a form-locking connection with the outer sleeve.

25. The brake system as defined by claim 22, wherein for mechanically coupling the coupling rod to the coupling plunger, the evaluation and control unit deactivates the retention device, as a result of which the bolt, which is subjected to force by a spring, moves inside the inner sleeve in such a way that the at least one ball is pressed outward from its outset position by the bolt into at least one of the corresponding receiving depressions in the outer sleeve, so that the inner sleeve forms a form-locking connection with the outer sleeve.

26. The brake system as defined by claim 12, wherein the force shunt couples the brake pedal as needed to the piston of the master cylinder in such a way that the proportion of the pedal force, generated at the brake pedal, that acts on the piston of the master cylinder is continuously variably adjustable.

27. The brake system as defined by claim 14, wherein the force shunt couples the brake pedal as needed to the piston of the master cylinder in such a way that the proportion of the pedal force, generated at the brake pedal, that acts on the piston of the master cylinder is continuously variably adjustable.

28. The brake system as defined by claim 16, wherein the force shunt couples the brake pedal as needed to the piston of the master cylinder in such a way that the proportion of the pedal force, generated at the brake pedal, that acts on the piston of the master cylinder is continuously variably adjustable.

29. The brake system as defined by claim 26, wherein the brake pedal is coupled to the pedal simulator and to the piston of the master cylinder via a coupling rod and the force shunt, and the force shunt is embodied as a lever with a guide in which guide one end, acting as a pivot point, of the coupling rod is guided, and the lever ratio between a second coupling point, at which the pedal simulator is coupled to the force shunt via a first transmission rod, and a third coupling point, at which the piston of the master cylinder is coupled to the force shunt via a second transmission rod, is adjustable by displacement of the pivot point, and the proportion of the pedal force acting on the piston of the master cylinder is adjustable via the lever ratio.

30. The brake system as defined by claim 11, wherein during a second mode of operation, preferably an emergency mode of operation, the brake pedal is coupled mechanically to the piston of the master cylinder, in order to transmit the pedal force, generated at the brake pedal, fully to the piston of the master cylinder, and during the second mode of operation, the pedal simulator is deactivated and/or bypassed.
